(19) United States
(12) Patent Application Publication
(10) Pub. No.: US 2020/0215888 A1
(43) Pub. Date: Jul. 9, 2020

(54) Inflatable vehicle cover for hail protection

(71) Applicant: Yiwei Zhang, PLANO, TX (US)

(72) Inventor: Yiwei Zhang, PLANO, TX (US)

(21) Appl. No.: 16/752,660

(22) Filed: Jan. 26, 2020

Related U.S. Application Data
(60) Provisional application No. 62/845,343, filed on May 9, 2019.

(51) Int. Cl. B60J 7/12

(52) U.S. Cl. CPC B60J 7/1204

(57) ABSTRACT

The inflatable vehicle cover is consisted of multiple layers of air pads to protect vehicle body from hail damage. The air pads are stacked over vehicle body. The non-return valve connects each adjacent air pad. Each air pad is self-contained after inflation. Even if the outer layer air pad is damaged by the hailstone, the inner layer air pad still can keep the air fluid to protect the vehicle from subsequent falling hailstones.

The inflatable vehicle cover also provides a resealable gate near vehicle driver door. User can access the vehicle to connect or disconnect portable air pump to vehicle power outlet. The vehicle cover near vehicle exhaust tail pipe can be folded up before turns on the vehicle engine.

Classifications

B60J11/00 Removable external protective coverings specially adapted for vehicles or parts of vehicles, e.g. parking covers

### PRIORITY ENTITLEMENT

This application is entitled to priority based on Provisional Patent Application Ser. No. 62/845,343 filed on May 9, 2019, which is incorporated herein for all purposes by this reference. This application and the Provisional Patent Application have at least one common inventor.

### TECHNICAL HELD

The present invention relates to covers for vehicles or other large objects which can be inflated to protect objects from hail damage.

### BACKGROUND

Each year, millions of vehicles been damaged during the hailstorm all over the world. The hailstone size could vary from 0.2 inch (0.5 cm) to 6 inch (15 cm). A hailstone which is bigger than 0.8 inch (2 cm) is considered larger enough to cause damage. During the hailstorm, if the vehicle couldn't be parked under shelter such as parking garage or covered parking lot, the use of inflatable vehicle cover is an effective solution to avoid or mitigate the hail damage.

There are some inflatable vehicle covers have been described in the prior arts.

U.S. Pat. No. 8,985,672B2 and U.S. Pat. No. 6,439,644B1 described an inflatable chamber. The inflatable chamber needs at least one blower to blow outside air into the inflatable chamber constantly for maintaining air chamber in an inflated state.

U.S. Pat. No. 7,360,820B2 described an inflatable apparatus is comprising of three groups of plurality of parallel longitudinal airway chambers. A plurality of check valves, deflating valves and inflating valves been used on each of the parallel longitudinal airway chambers.

U.S. Pat. No. 7,640,698B2 described an inflatable cover comprises multiple pockets in fluid communication with each other and with an integrated compartment, the pockets of the cover configured for nested engagement against a body of a vehicle.

While those prior arts may be suitable for the particular purpose they addressed, however, those design may be cumbersome, difficult to use and no redundant protection. None of the them disclose the unique designs of the present invention heretofore described.

### SUMMARY OF THE INVENTION

The present invention designs the inflatable, light weight and redundant protection vehicle cover.

The present invention designs the vehicle cover is consisted of multiple layers of stacked air pads. The closer layer to vehicle is considered as inner layer. The further outside layer to vehicle is considered as outer layer. In between the inner layer and outer layer, the middle layer is optional.

The present invention designs non-return valves to connect between outer layer and inner layer.

The present invention designs a resealable gate near vehicle driver door.

The present invention designs an air inlet and outlet near resealable gate. The air inlet is in fluid communication with outer layer air pad. The air outlet is in fluid communication with inner layer air pad through middle(optional) and outer layer air pads.

The present invention designs a foldable cover near vehicle exhaust tail pipe to prevent the damage from vehicle exhaust gas when vehicle engine is turned on.

The present invention designs at least three adjustable fastener straps to secure vehicle cover. One located in front of front tire, the second one located behind the rear tire and the third one located around the bottom of vehicle cover.

The above unique designs of present invention provide following main advantages.

The vehicle cover is capable of redundant protection. Because the non-return valves connected between the air pads, each air pad will be self-contained after inflation. The multiple self-contained air pads provide redundant protection. During the severe hailstorm, even if the outer layer air pad is damaged and leaked, the inner air pad can keep the air fluid which will protect the vehicle from subsequent falling hailstones.

The vehicle cover is easy to operate. The user can access vehicle easily through the resealable gate near the driver door. The user can connect the portable air pump to vehicle power outlet for inflation and deflation. When inflating, the air pump is connected to air inlet. The air flows only one direction from outside to outer air pad and then to inner air pad. When deflating, the air pump is connected to air outlet. The air flows only one direction from outer air pad to inner air pad and then to outside.

The present invention will largely reduce the product weight and increase reliability. Only few non-return valves are needed to connect between outer and inner layer air pads because the air pads are stacked, unlike prior art using plurality of check valves, inflating and deflating valves.

### BRIEF DESCRIPTION OF THE DRAWINGS

FIG. 1 is a side view of vehicle which the vehicle cover been installed and inflated.

FIG. 2 is a vertical view of the present invention when resealable gate is opened.

FIG. 3 is a cross-sectional view of the inflatable vehicle cover shown in FIG. 1 taken along line A-A.

FIG. 4 is a rear view of foldable cover near vehicle exhaust tail pipe.

### DETAILED DESCRIPTION OF THE INVENTION

The present invention is explained in the detailed description with reference numbers remarked in drawing. The descriptive and directional terms used in the written description such as front, rear, top, bottom, inner, outer, et cetera, refer to the drawings themselves as laid out on the paper and not to physical limitations of the invention unless specifically noted. The drawings are not to scale. Some description shown and discussed are simplified or amplified for illustrating principles and features as well as advantages of the invention.

The Inflatable vehicle cover is made of lightweight, waterproof, fast drying and abrasion resistant material. The vehicle cover is consisted of multiple layers of air pads which are shaped to cover the entire exposed vehicle body. When the vehicle cover is not in use, it is flat and stowed.

Before hailstorm approaching, the user can install the flat vehicle cover as illustrated on FIG. 1 while the vehicle engine is off. The vehicle cover [01] is set to cover the entire exposed vehicle body.

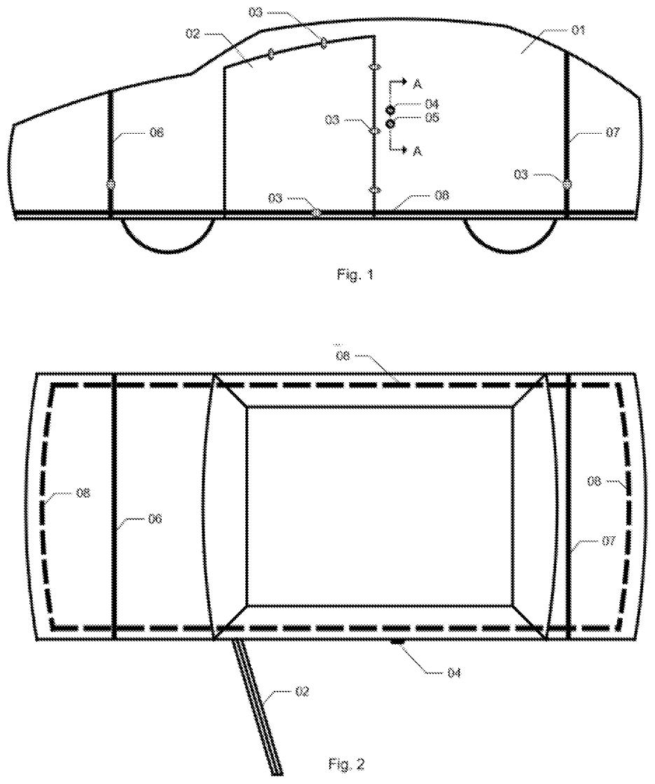

Before inflation, the foldable cover [13] near vehicle exhaust tail pipe [14] is folded up as illustrated on FIG. 4. The user opens the resealable gate [02] as illustrated on FIG. 2 to easily get in and out of the vehicle.

The user plugs the portable air pump into vehicle power outlet and then turns on the vehicle engine. The user connects the air pump to air inlet [04] and starts inflating while air outlet [05] is closed. During the inflation, the air pump blows the air fluid from outside to outer air pad. Once the outer air pad is full, the air flows from outer air pad to inner air pad. When all air pads are fully inflated, the inflation is completed. The user can close the air inlet, disconnect the air pump and turn off the vehicle engine.

The user buckles up resealable gate to other part of vehicle cover using buckle clips [03]. The resealable gate seamlessly covers the vehicle door.

The user folds down the foldable cover to protect the rear part of vehicle.

The adjustable fastener strap [06] is located in front of the front wheel. The adjustable fastener strap [07] is located behind the rear wheel. The user can take one end of straps [06] and [07], go around the vehicle, and tight to the other end of straps. The adjustable fastener strap [08] is located at bottom of vehicle cover. The user secures the fastener strap [08].

Now the vehicle cover is inflated and tightly secured to protect vehicle from hail damage.

After hailstorm, the user can un-tight the fastener straps. The user connects the potable air pump to air outlet [05] to deflate the vehicle cover. During the deflation, the air pump will reverse the air flow direction which sucks the air from vehicle cover to outside. The air flows only one direction from outer air pad to inner air pad and then to outside. Once all air pads are fully flat, the deflation is completed. The user can remove the cover from vehicle and stow it.

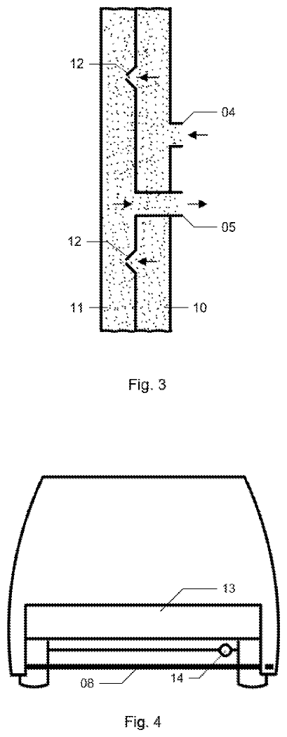

The FIG. 3 is a cross-sectional view of the inflatable vehicle cover shown in FIG. 1 taken along line A-A. The air inlet [04] is in fluid communication with outer layer air pad [10]. The air outlet [05] is in fluid communication with inner layer air pad [11]. The outer layer and inner layer are connected by non-return valve [12].

1. An inflatable vehicle cover is consisted of multiple layers of air pads, at least one non-return valve to connect adjacent air pad, air inlet, air outlet and at least three adjustable fastener straps.

2. The inflatable vehicle cover of claim 1, wherein the outer layer air pad, inner layer air pad and optional middle layer air pad are inflatable and stacked over vehicle body.

3. The inflatable vehicle cover of claim 1, wherein the non-return valve allows only one direction air fluid communication which is from outer layer air pad to middle(optional) and inner layer air pad.

4. The inflatable vehicle cover of claim 1, wherein the air inlet is in fluid communication with outer layer air pad, the air outlet in fluid communication with inner layer air pad through both middle(optional) and outer layer air pads.

5. The inflatable vehicle cover of claim 1, wherein a resealable gate is located near vehicle driver door.

6. The inflatable vehicle cover of claim 4, wherein the air inlet and air outlet are located near resealable gate.

7. The inflatable vehicle cover of claim 1, wherein the cover near vehicle exhaust tail pipe is foldable.

8. The inflatable vehicle cover of claim 1, wherein one adjustable fastener strap located in front of front tire, the second one located behind the rear tire and the third one located around the bottom of vehicle cover.
